(19) United States
(12) Patent Application Publication
(10) Pub. No.: US 2025/0238415 A1
(43) Pub. Date: Jul. 24, 2025

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Masafumi Enomoto, Tokyo (JP); Yuyang Dong, Tokyo (JP); Masafumi Oyamada, Tokyo (JP); Takuma Nozawa, Tokyo (JP)

(73) Assignee: NEC Corporation, Minato-ku, Tokyo (JP)

(21) Appl. No.: 18/699,628

(22) PCT Filed: Oct. 25, 2021
(86) PCT No.: PCT/JP2021/039224

§ 371 Date: Apr. 9, 2024

(51) Int. Cl. G06F 16/23

(52) U.S. Cl. CPC G06F 16/2365

(57) ABSTRACT

To correct an error related to an attribute of data with higher accuracy without requiring large amounts of training data, an information processing apparatus (1) includes: a data obtaining section (11) that obtains target data; an error attribute identification section (12) that identifies an error attribute that is an attribute including an error, from among a plurality of attributes contained in processed data obtained by applying a predetermined process to the target data; a reference attribute identification section (13) that identifies a reference attribute that is an attribute similar to the error attribute and contained in the target data; a prediction section (14) that predicts a correction related to the error attribute; and a revision section (15) that revises the correction with reference to the reference attribute.

### TECHNICAL FIELD

The present invention relates to an information processing apparatus, an information processing method, and an information processing program.

### BACKGROUND ART

Techniques for integrating a variety of databases (heterogeneous databases) with different attributes are known. Non-patent Literature 1 discloses, as a technique for classifying a large number of items into 35 commodity categories, a technique for training a predictive model for predicting categories in accordance with explanatory variables such as the product name with use of classified data as training data, and automatically classifying newly input data with use of this predictive model. Use of this technique disclosed in Non-patent Literature 1 allows correction of an error found during integration of heterogeneous databases.

### CITATION LIST

### Non-Patent Literature

### [Non-patent Literature 1]

Yandi Xia, et. al., ‘Large-Scale Categorization of Japanese Product Titles Using Neural Attention Models’, Proceedings of the 15th Conference of the European Chapter of the Association for Computational Linguistics: Volume 2, Short Papers, pages 663-668, April, 2017

### SUMMARY OF INVENTION

### Technical Problem

However, the technique disclosed in Patent Literature 1 requires large amounts of training data to train the predictive model, and there is a problem in that few training data cannot correct an error with high accuracy.

An example aspect of the present invention has been made in view of this problem, and an example object thereof is to provide a technique capable of correcting an error related to an attribute of data with high accuracy without requiring large amounts of training data.

### Solution to Problem

An information processing apparatus in accordance with an example aspect of the present invention, includes: data obtaining means for obtaining target data; error attribute identification means for identifying an error attribute that is an attribute including an error, from among a plurality of attributes contained in processed data obtained by applying a predetermined process to the target data; reference attribute identification means for identifying a reference attribute that is an attribute similar to the error attribute and contained in the target data; prediction means for predicting a correction related to the error attribute; and revision means for revising the correction with reference to the reference attribute.

An information processing method in accordance with an example aspect of the present invention, includes: obtaining target data; identifying an error attribute that is an attribute including an error, from among a plurality of attributes contained in processed data obtained by applying a predetermined process to the target data; identifying a reference attribute that is an attribute similar to the error attribute and contained in the target data; predicting a correction related to the error attribute; and revising the correction with reference to the reference attribute.

An information processing program in accordance with an example aspect of the present invention is a program for causing a computer to carry out: a process of obtaining target data; a process of identifying an error attribute that is an attribute including an error, from among a plurality of attributes contained in processed data obtained by applying a predetermined process to the target data; a process of identifying a reference attribute that is an attribute similar to the error attribute and contained in the target data; a process of predicting a correction related to the error attribute; and a process of revising the correction with reference to the reference attribute.

### Advantageous Effects of Invention

According to an example aspect of the present invention, it is possible to correct an error related to an attribute of data with high accuracy without requiring large amounts of training data.

### BRIEF DESCRIPTION OF DRAWINGS

FIG. 1 is a block diagram illustrating the configuration of an information processing apparatus in accordance with a first example embodiment.

FIG. 2 is a flowchart illustrating the flow of an information processing method in accordance with the first example embodiment.

FIG. 3 is a block diagram illustrating the configuration of an information processing apparatus in accordance with a second example embodiment.

FIG. 4 is a diagram illustrating a specific example of standard data and target data in accordance with the second example embodiment.

FIG. 5 is a flowchart illustrating the flow of processing carried out by the information processing apparatus in accordance with the second example embodiment.

FIG. 6 is a diagram illustrating a specific example of metadata in accordance with the second example embodiment.

FIG. 7 is a diagram illustrating a specific example of processed data in accordance with the second example embodiment.

FIG. 8 is a diagram illustrating a specific example of an error determination condition in accordance with the second example embodiment.

FIG. 9 is a diagram illustrating a specific example of a revision performed by a revision section in accordance with the second example embodiment.

FIG. 10 is a diagram illustrating a specific example of integrated data in accordance with the second example embodiment.

FIG. 11 is a block diagram illustrating the configuration of a computer that functions as each of the information processing apparatuses in accordance with the example embodiments.

### EXAMPLE EMBODIMENTS

### First Example Embodiment

The following description will discuss a first example embodiment of the present invention in detail with reference to the drawings. The present example embodiment is a basic form of example embodiments described later.

### <Configuration of Information Processing Apparatus 1>

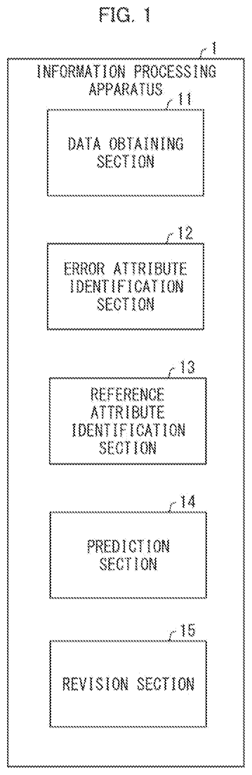

The following description will discuss the configuration of an information processing apparatus 1 in accordance with the present example embodiment with reference to FIG. 1. FIG. 1 is a block diagram illustrating the configuration of the information processing apparatus 1. For example, the information processing apparatus 1 may be a data integration apparatus that integrates data, a classification apparatus that classifies data, or a conversion apparatus that converts data. The information processing apparatus 1 includes a data obtaining section 11, an error attribute identification section 12, a reference attribute identification section 13, a prediction section 14, and a revision section 15. The data obtaining section 11 has a configuration for implementing data obtaining means in the present example embodiment. The error attribute identification section 12 has a configuration for implementing error attribute identification means in the present example embodiment. The reference attribute identification section 13 has a configuration for implementing reference attribute identification means in the present example embodiment. The prediction section 14 has a configuration for implementing prediction means in the present example embodiment. The revision section 15 has a configuration for implementing revision means in the present example embodiment.

The data obtaining section 11 obtains target data. Here, the target data is data to which a predetermined process is applied, and may be, for example, a database that contains one or more records. However, the target data is not limited to this example, but may be other data. The target data contains one or more attributes. Each attribute contained in the target data indicates a feature of the target data or a feature of data contained in the target data, and, may be, for example, a field contained in the database which is the target data. However, the one or more attributes contained in the target data are not limited to these examples, but may be other attributes.

The error attribute identification section 12 identifies an error attribute that is an attribute including an error, from among a plurality of attributes contained in processed data obtained by applying the predetermined process to the target data. Here, the predetermined process is a process applied to the target data, and may be, for example, a process of converting a record contained in the database which is the target data, into a data format of another database. It should be noted that the predetermined process is not limited thereto, but may be any process, provided that the processing can be applied to the target data. Each attribute contained in the processed data indicates a feature of the processed data or a feature of data contained in the processed data, and may be, for example, a field contained in the database which is the processed data. However, the attributes contained in the processed data are not limited to these examples, but may be other attributes. The attribute including an error may include, for example, an attribute having the attribute value that does not satisfy a predetermined condition, or an attribute with no attribute value set.

The reference attribute identification section 13 identifies a reference attribute that is an attribute similar to the error attribute and contained in the target data. As the reference attribute, the reference attribute identification section 13 may identify, for example, from among the plurality of attributes contained in the target data, such an attribute that has a similarity to the error attribute satisfying a predetermined condition, the error attribute being identified by the error attribute identification section 12. More specifically, as an example, the reference attribute identification section 13 may identify the reference attribute, using a technique in which a schema definition of two tables is given in a file and the similarity between fields of the two tables is outputted, that is, a technique of so-called schema matching. Examples of the scheme matching method may include a method disclosed in a non-patent literature “Bernstein, Philip A., Jayant Madhavan, and Erhard Rahm. ‘Generic schema matching, ten years later.’, Proceedings of the VLDB Endowment 4.11 (2011): 695-701.” However, the method in which the reference attribute identification section 13 identifies the reference attribute is not limited to these examples, and the reference attribute identification section 13 may identify the reference attribute, using another method.

The prediction section 14 predicts a correction related to the error attribute. Here, the “correction” means details of correction to be made on the processed data, and may include, for example, a corrected attribute value of the error attribute contained in the processed data. As an example, the prediction section 14 may predict a plurality of attribute values that may be set in the error attribute of the processed data as a plurality of correction candidates.

The revision section 15 revises the correction with reference to the reference attribute. As an example, the revision section 15 may identify, with reference to the reference attribute, a revised correction from among the plurality of correction candidates predicted by the prediction section 14. More specifically, as an example, the revision section 15 may identify the revised correction with reference to: (i) the plurality of correction candidates, (ii) a first certainty factor, (iii) one or more attribute value candidates for the reference attribute; (iv) a second certainty factor, and (v) the similarity between each of the correction candidates and each of the attribute value candidates. In this case, (i) the plurality of correction candidates is a plurality of correction candidates predicted by the prediction section 14. (ii) The first certainty factor is a certainty factor related to each of the plurality of correction candidates. (iii) The one or more attribute value candidates for the reference attribute are a set of one or more attribute values that may be set in the reference attribute. (iv) The second certainty factor that is a certainty factor related to each of the one or more attribute value candidates.

Examples of the method of calculating (v) the similarity between each of the correction candidates and each of the attribute value candidates may include the following first to third methods. The first example of the method is a method in which words included in attribute values are collected to generate token sets and the similarities between the sets are calculated. In this case, the similarities between the sets may be, for example, the Jaccard coefficient, the Dice coefficient, or the Simpson coefficient. The second example of the method is a method in which each attribute value is handled as a single character string and the similarities between the attribute values are calculated. In this case, the similarities between the attribute values may be, for example, the Hamming distance or the Levenshtein distance. The third example of the method is a method in which after obtaining embedded vectors of attribute values, the distances between the vectors are calculated, using a distance function. In this case, for example, word2vec's algorithm can be used when obtaining the embedded vectors. For example, the distance function may be a function for calculating the Euclidean distance or the Manhattan distance. However, the method of calculating the similarity is not limited to the foregoing examples, and the similarity may be calculated by another method.

As described in the foregoing, the information processing apparatus 1 in accordance with the present example embodiment employs a configuration of: obtaining target data; identifying an error attribute that is an attribute including an error, from among a plurality of attributes contained in processed data obtained by applying a predetermined process to the target data; identifying a reference attribute that is an attribute similar to the error attribute and contained in the target data; predicting a correction related to the error attribute; and revising the correction with reference to the reference attribute. Thus, according to the information processing apparatus 1 in accordance with the present example embodiment, it is possible to achieve an example advantage of correcting an error related to an attribute of data with high accuracy without requiring large amounts of training data.

### <Information Processing Method>

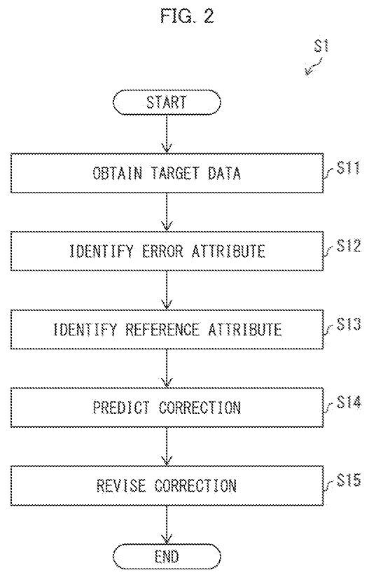

The following description will discuss the flow of an information processing method S1 in accordance with the present example embodiment with reference to FIG. 2. FIG. 2 is a flowchart illustrating the flow of the information processing method S1. In step S11, the data obtaining section 11 obtains target data. In step S12, the error attribute identification section 12 identifies an error attribute that is an attribute including an error, from among a plurality of attributes contained in processed data obtained by applying a predetermined process to the target data. In step S13, the reference attribute identification section 13 identifies a reference attribute that is an attribute similar to the error attribute and contained in the target data. In step S14, the prediction section 14 predicts a correction related to the error attribute. In step S15, the revision section 15 revises the correction with reference to the reference attribute.

As described in the foregoing, the information processing method S1 in accordance with the present example embodiment employs a configuration of: obtaining target data; identifying an error attribute that is an attribute including an error, from among a plurality of attributes contained in processed data obtained by applying a predetermined process to the target data; identifying a reference attribute that is an attribute similar to the error attribute and contained in the target data; predicting a correction related to the error attribute; and revising the correction with reference to the reference attribute. Thus, according to the information processing method S1 in accordance with the present example embodiment, it is possible to achieve an example advantage of correcting an error related to an attribute of data with high accuracy without requiring large amounts of training data.

### Second Example Embodiment

The following description will discuss a second example embodiment of the present invention in detail with reference to drawings. It should be noted that any constituent element that is identical in function to a constituent element described in the first example embodiment will be given the same reference symbol, and a description thereof will not be repeated.

### (Configuration of Information Processing Apparatus)

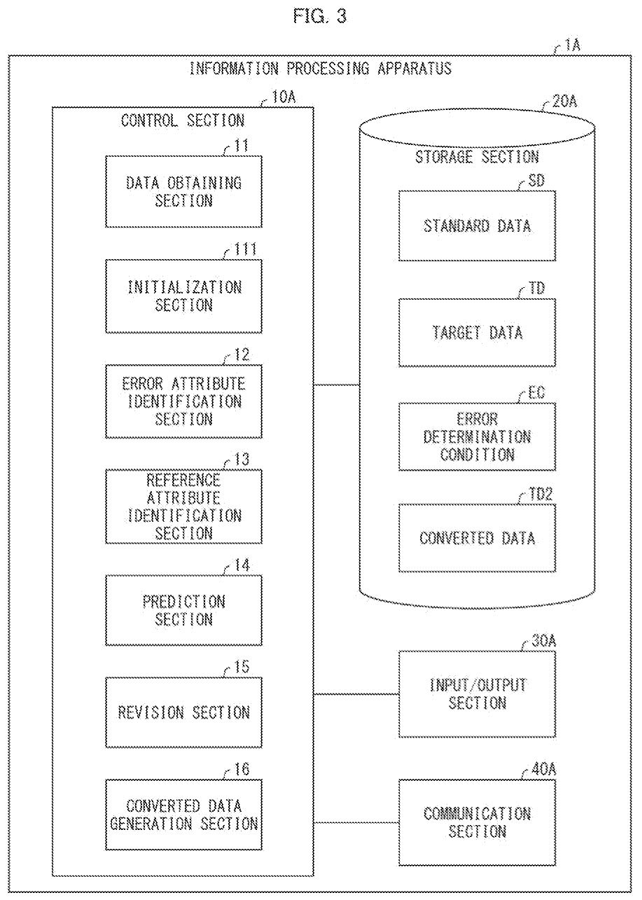

The following description will discuss the configuration of an information processing apparatus 1A in accordance with the present example embodiment with reference to FIG. 3. FIG. 3 is a block diagram illustrating the configuration of the information processing apparatus 1A. As an example, the information processing apparatus 1A may be an apparatus that integrates a plurality of databases having different attributes. The information processing apparatus 1A includes a control section 10A, a storage section 20A, an input/output section 30A, and a communication section 40A.

The communication section 40A communicates with an apparatus external to the information processing apparatus 1A via a communication line. For example, the communication line may be a wireless local area network (LAN), a wired LAN, a wide area network (WAN), a public network, a mobile data communication network, or a combination thereof. The communication section 40A transmits data provided by the control section 10A to another apparatus and provides data received from another apparatus to the control section 10A.

To the input/output section 30A, an input/output apparatus such as a keyboard, a mouse, a display, a printer, and a touch panel is connected. The input/output section 30A receives input of various kinds of information to the information processing apparatus 1A from a connected input apparatus. Further, the input/output section 30A outputs various kinds of information to an output apparatus connected thereto, under the control of the control section 10A. Examples of the input/output section 30A may include an interface such as universal serial bus (USB).

As illustrated in FIG. 3, the control section 10A includes a data obtaining section 11, an initialization section 111, an error attribute identification section 12, a reference attribute identification section 13, a prediction section 14, a revision section 15, and a converted data generation section 16.

The data obtaining section 11 obtains target data, similarly to the first example embodiment. As an example, the data obtaining section 11 may obtain the target data from another apparatus via the communication section 40A or the input/output section 30A. The target data may be, for example, a database that contains a plurality of records.

The initialization section 111 applies an initialization process to the target data as a predetermined process. Here, as the initialization process, the initialization section 111: refers to correspondence information indicating a correspondence between at least one of the plurality of attributes contained in the target data and at least one of a plurality of attributes contained in standard data; and, from the target data, generates, as the processed data, data containing attributes identical to the plurality of attributes contained in the standard data.

Similarly to the first example embodiment, the error attribute identification section 12 identifies an error attribute that is an attribute including an error, from among a plurality of attributes contained in processed data obtained by applying the predetermined process to the target data. Details of the process of identifying the error attribute will be described later. Similarly to the first example embodiment, the reference attribute identification section 13 identifies a reference attribute that is an attribute similar to the error attribute and contained in the target data. Details of the process of identifying the reference attribute will be described later.

Similarly to the first example embodiment, the prediction section 14 predicts a correction related to the error attribute. Details of the process of predicting the correction will be described later. Similarly to the first example embodiment, the revision section 15 revises the correction with reference to the reference attribute. Details of the process of revising the correction will be described later.

The converted data generation section 16 generates converted data corresponding to the target data, using the correction revised by the revision section 15. Details of the process of generating the converted data will be described later.

### (Storage Section 20A)

The storage section 20A stores various data to be referred to by the control section 10A. As an example, the storage section 20A may store standard data SD, target data TD, error determination condition EC, and converted data TD2, as illustrated in FIG. 3.

The standard data SD is data that serves as a standard for conversion or integration of data, and may be, for example, a database that contains one or more records. When the standard data SD is a database that contains n records, the standard data SD can be expressed as a set of records sd1, sd2, . . . , sdn, that is, {sdi}_{iϵ[n]}. Here, i and n is a natural number of 1 or more, and n is the number of records contained in the standard data SD.

The target data TD is data obtained by the data obtaining section 11 and is a target of conversion or integration carried out by the information processing apparatus 1A. As an example, the target data TD may be a database that contains one or more records and contains one or more attributes different from those of the standard data SD. When the target data TD is a database that contains m records, the target data TD can be expressed as a set of records td1, td2, . . . tdm, that is, {tdj}_{jϵ[m]}. Here, i and m is a natural number of 1 or more, and m is the number of records contained in the target data TD.

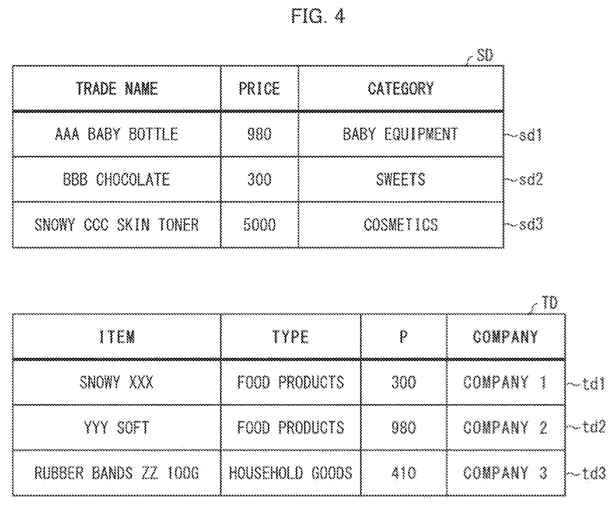

FIG. 4 is a diagram illustrating a specific example of the standard data SD and the target data TD. In the example of FIG. 4, the standard data SD and the target data TD are databases each containing a plurality of records. The standard data SD illustrated in FIG. 4 contains fields (attributes) of “trade name”, “price”, and “category”. The standard data SD contains: record sd1 in which “trade name”, “price”, and “category” have the attribute values of “AAA baby bottle”, “980”, and “baby equipment”, respectively; record sd2 in which “trade name”, “price”, and “category” have the attribute values of “BBB chocolate”, “300”, and “sweets”, respectively; and record sd3 in which “trade name”, “price”, and “category” have the attribute values of “snowy CCC skin toner”, “5000”, and “cosmetics”, respectively. It should be noted that the records contained in the standard data SD are not limited to these examples, and the standard data SD may contain records having various attribute values other than these examples. Further, although FIG. 4 illustrates a case where the number of records contained in the standard data SD is three, the number of records contained in the standard data SD may be more or less.

The target data TD illustrated in FIG. 4 contains fields of “item”, “type”, “p”, and “company”. The target data TD contains: record td1 in which “item”, “type”, “p”, and “company” have the attribute values of “snowy XXX”, “food products”, “300”, and “Company 1”, respectively; record td2 in which “item”, “type”, “p”, and “company” have the attribute values of “YYY soft”, “food products”, “980”, and “Company 2”, respectively; and record td3 in which “item”, “type”, “p”, and “company” have the attribute values of “rubber bands ZZ 100 g”, “household goods”, “410”, and “Company 3”, respectively. It should be noted that the records contained in the target data TD are not limited to these examples, and the target data TD may contain records having various attribute values other than these examples. Further, although FIG. 4 illustrates a case where the number of records contained in the target data TD is three, the number of records contained in the target data TD may be more or less.

The error determination condition EC is a condition for determining whether the processed data obtained by applying the predetermined process to the target data includes any errors. A specific example of the error determination condition EC will be described later.

The converted data TD2 is data obtained by the converted data generation section 16 converting the target data TD. When the target data TD is a database that contains m records, the converted data TD2 can be expressed as a set of converted records td2j, that is, {td2j}_{jϵ[m]}. obtained by converting records tdj contained in the target data TD.

### <Flow of Information Processing Method Carried Out by Information Processing Apparatus 1A>

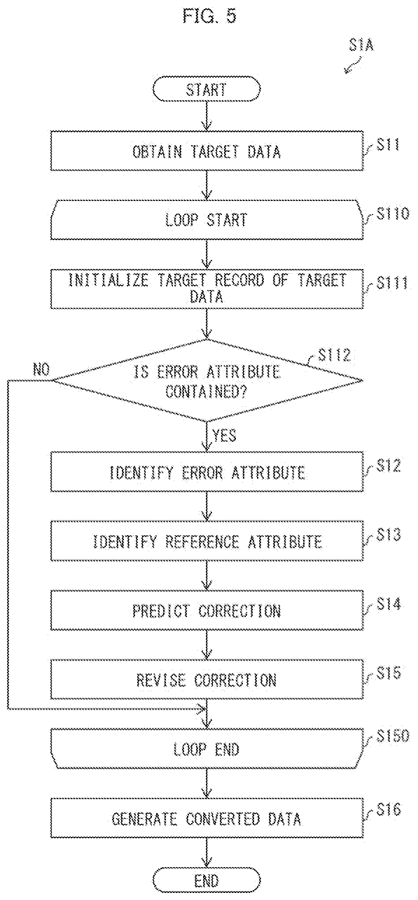

The following description will discuss the flow of an information processing method S1A carried out by the information processing apparatus 1A configured as described in the foregoing, with reference to FIG. 5. FIG. 5 is a flowchart illustrating the flow of the information processing method S1A. It should be noted that descriptions of the contents already described will not be repeated. As an example, the information processing method S1A may be a method of integrating the target data TD illustrated in FIG. 4 into the standard data SD.

### (Step S11)

In step S11, the data obtaining section 11 obtains target data TD. For example, the data obtaining section 11 may receive the target data TD from another apparatus via the communication section 40A, or alternatively, may obtain the target data TD inputted via the input/output section 30A. Further, the data obtaining section 11 may obtain the target data TD by reading the target data TD from the storage section 20A or an external storage.

Further, in step S11, the data obtaining section 11 may obtain an error determination condition EC and metadata M. In this case, for example, the data obtaining section 11 may receive the error determination condition EC and the metadata M from another apparatus via the communication section 40A, or alternatively, may obtain the error determination condition EC and the metadata M inputted via the input/output section 30A. Further, the data obtaining section 11 may obtain the error determination condition EC and the metadata M by reading the error determination condition EC and the metadata M from the storage section 20A or an external storage. The timings at which the data obtaining section 11 obtains the target data TD, the error determination condition EC, and the metadata M may be the same, or may be different.

The metadata M is a set of various pieces of information related to standard data SD and the target data TD. As an example, the metadata M may include a dictionary that represents a correspondence between an attribute of the standard data SD and an attribute of the target data TD. Further, as an example, the metadata M may include at least one selected from the group consisting of the attribute names, the titles, and the captions of the standard data SD and the target data TD. The metadata M is an example of correspondence information in accordance with the present specification. A specific example of the metadata M will be described later.

### (Step S110)

Step S110 is the beginning of loop of a process related to a record of the target data TD. Here, loop variable j in the loop of the process related to the record is a natural number satisfying 1≤j≤m. In the following description, record tdj contained in the target data TD is also referred to as “target record tdj”. Further, record sdi contained in the standard data SD is also referred to as “standard record sdi”.

### (Step S111)

In step S111, the initialization section 111 executes an initialization process that initializes the target record tdj of the target data TD with reference to the correspondence information. More specifically, the initialization section 111 generates, from the target record tdj, with reference to the correspondence information, a record containing attributes identical to a plurality of attributes contained in the standard data SD, as processed record tᵢₙᵢₜ.

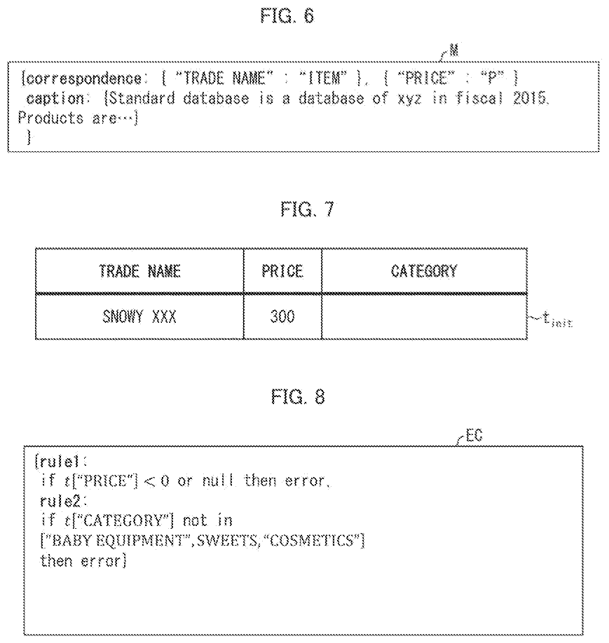

FIG. 6 is a diagram illustrating a specific example of the metadata M, which is an example of the correspondence information. In the example of FIG. 6, the metadata M contains information indicating that “product name” and “item” correspond to each other, information indicating that “price” and “p” correspond to each other, and the caption of the standard data SD.

FIG. 7 is a diagram illustrating a specific example of the processed record tᵢₙᵢₜ obtained by applying the initialization process to the target record tdj of the target data TD illustrated in FIG. 4. In the example of FIG. 7, the initialization section 111 converts the target record tdj into the processed record tᵢₙᵢₜ containing attributes identical to those contained in the standard data SD of FIG. 4, that is, “trade name”, “price”, and “category”. At this time, the initialization section 111 refers to the metadata M illustrated in FIG. 6, and sets “trade name” of the processed record tᵢₙᵢₜ to have an attribute value of “snowy XXX”, which is the attribute value of the attribute “item” of the target record td1 corresponding to the “trade name”. Further, the initialization section 111 refers to the metadata M, and sets “price” of the processed record tᵢₙᵢₜ to have an attribute value of “300”, which is the attribute value of the attribute “p” of the target record td1 corresponding to the “price”. However, among the fields contained in the processed record tᵢₙᵢₜ, no attribute value is set in the field “category” for which no correspondence is indicated in the metadata M.

The attribute “category” in which no attribute value is set is an error attribute contained in the processed record tᵢₙᵢₜ. As described in the foregoing, since the attributes of the standard data SD and those of the target data TD do not necessarily correspond to each other, the processed record tᵢₙᵢₜ generated by the initialization process may include an error attribute.

### (Step S112)

In step S112 of FIG. 5, the error attribute identification section 12 determines whether or not the processed record tᵢₙᵢₜ contains an error attribute, that is, whether or not the attribute value of each attribute satisfies a predetermined condition for each of the plurality of attributes contained in the processed record tᵢₙᵢₜ. As an example, the predetermined condition may be the error determination condition EC stored in the storage section 20A.

FIG. 8 is a diagram illustrating a specific example of the error determination condition EC. In the example of FIG. 8, the error determination condition EC includes “rule1” and “rule2”. The “rule1” is a rule instructing that it is determined to be an error when the value of the field “price” contained in the processed record tᵢₙᵢₜ is less than 0, or when no value is set in the field “price”. The “rule2” is a rule instructing that it is determined to be an error when the value of the field “category” contained in the processed record tᵢₙᵢₜ is not “baby equipment”, “sweets”, or “cosmetics”. In a case of the processed record tᵢₙᵢₜ of FIG. 7, the error attribute identification section 12 determines whether or not each of “product name”, “price”, and “category” satisfies the error determination condition EC of FIG. 8. It should be noted that the predetermined condition in accordance with the present specification is not limited to the example of FIG. 8, but may be any condition for determining whether the processed data includes an error.

In a case where the processed record tᵢₙᵢₜ contains an error attribute (YES in step S112), the error attribute identification section 12 proceeds to step S12. On the other hand, when the processed record tᵢₙᵢₜ contains no error attribute (NO in step S112), the error attribute identification section 12 skips steps S12 to S15, and proceeds to step S150.

### (Step S12)

In step S12, the error attribute identification section 12 identifies the error attribute based on the determination result. In other words, the error attribute identification section 12 identifies a set F of one or more error attributes k. In the example of FIG. 7, among the “trade name”, “price”, and “category” of the processed record tᵢₙᵢₜ, the attribute value of “category” of the processed record tᵢₙᵢₜ is not “baby equipment”, “sweets”, or “cosmetics”, so that the error attribute identification section 12 identifies “category” as an error attribute k based on the error determination condition EC. In other words, one error attribute k contained in the processed record tᵢₙᵢₜ of FIG. 7 is “category”. Further, since the other attributes satisfy the error determination condition EC, the set F of one or more error attributes k is a set composed of the only element of “category”.

### (Step S13)

In step S13, the reference attribute identification section 13 identifies a reference attribute k′, which is an attribute that is similar to each of the one or more error attributes k and is contained in the target data TD. As an example, the reference attribute identification section 13 may identify a reference attribute that is an attribute similar to each error attribute k semantically or linguistically and contained in the target data TD. More specifically, as an example, the reference attribute identification section 13 may identify a reference attribute, using a technique in which a schema definition of two tables is given in a file and a similarity between fields of the two tables is outputted, that is, a technique of so-called schema matching.

More specifically, regarding the schema matching, as an example, the reference attribute identification section 13 may identify a reference attribute similar to an error attribute based on the name of attribute, the caption, the stemming, tokenization, matching of a character string and a partial character string, and a language matching technique based on an information retrieval technique. In this case, the reference attribute identification section 13 may use auxiliary information such as a thesaurus, an acronym, a dictionary, and a mismatch list. It should be noted that the method of identifying a reference attribute is not limited to the foregoing methods, and the reference attribute identification section 13 may identify a reference attribute similar to an error attribute using another method.

In the example of FIG. 4, the reference attribute identification section 13 identifies “type” as the reference attribute k′ from among the plurality of fields contained in the target data TD.

### (Step S14)

In step S14, the prediction section 14 predicts a correction Pk related to the error attribute k. As an example, the prediction section 14 may predict a correction Pk including a plurality of correction candidates yck related to the error attribute k. In other words, the prediction section 14 predicts a plurality of correction candidates yck related to the error attribute k. As a specific example of the method in which the prediction section 14 predicts the correction candidates yck, the following will describe (i) a method using a predictive model and (ii) a method using a similarity vector.

### (Method Using Predictive Model)

As an example, the prediction section 14 may calculate a feature vector vtj of the target record tdj contained in the target data TD, input the calculated feature vector vtj into a predictive model f, and output a correction candidate yck in accordance with a value outputted from the predictive model f. Here, as an example, the number of dimensions of the feature vector vtj may be the number of attributes contained in the target data TD. As an example, the feature vectors vt1 to vt3 of the records td1 to td3 in FIG. 4 may be expressed as {0.9, 0.2, −0.1, 1.5, 0.3}, {0.6, −0.3, 0.1, 0.7, −1.2}, and {0.4, 0.6, −0.8, 0.9, −0.3}, respectively.

It should be noted that the number of dimensions of the feature vector vtj is not limited to the number of attributes contained in the target data TD. For example, the prediction section 14 may use an embedded vector of the target data TD as the feature vector vtj. In this case, the prediction section 14 can use any existing algorithm such as word2vec to obtain the embedded vector.

As an example, the correction Pk of the error attribute k may be expressed as Equation (1).

$$Pk = {\{ ( yck , sck ) \}}_{c ∈ {N}_{k}} \qquad ( 1 )$$

Here, the attribute value cϵNₖ is an attribute value of the correction candidate for the error attribute k, and the set Nₖ is a set of attribute values c. The number of candidates for the correction for each error attribute kϵF is |Nₖ|.

Each correction candidate yck is a correction candidate of the attribute value of the error attribute k. The first certainty factor sck is a certainty factor related to each of the plurality of correction candidates yck. That is, in the above Equation (1), the correction Pk is a set of pairs of the correction candidates yck and the first certainty factors sck of the corresponding correction candidates yck.

As an example, the prediction section 14 may calculate the first certainty factor sck, using the predictive model f. However, the unit for carrying out the calculation process of the first certainty factor sck is not limited to the prediction section 14, and may be carried out by a unit other than the prediction section 14, such as the revision section 15. Further, the calculation process of the first certainty factor sck may be carried out by another apparatus other than the information processing apparatus 1A. For example, the data obtaining section 11 or the like may obtain the first certainty factor sck calculated by another apparatus via the input/output section 30A or the communication section 40A.

As an example, the predictive model f may be constructed by machine learning. As an example, the predictive model f may be a predictive model that receives a feature vector vtj as input and outputs a pair of a correction candidate yck and a corresponding first certainty factor sck. The training of the predictive model f may be carried out by the control section 10A of the information processing apparatus 1A, or may be carried out by another apparatus. The machine learning method of the predictive model is not limited, and, for example, a decision tree-based, linear regression, or neural network technique may be used, or alternatively, two or more of these methods may be used. Examples of the decision tree-based method may include Light Gradient Boosting Machine (LightGBM), random forest, and XGBoost. Examples of the linear regression may include Bayesian linear regression, support vector regression, Ridge regression, Lasso regression, and ElasticNet. Examples of the neural network may include deep learning.

### (First Specific Example of Predictive Model: Regression Model (Supervised Learning))

As an example, the predictive model f may be a regression model f1 generated by supervised learning. In this case, input of the regression model f1 is the feature vector vtj of the target record tdj, and output of the regression model f1 includes the pair of the correction candidate yck of the error attribute k and the corresponding first certainty factor sck. In other words, the prediction section 14 identifies the correction Pk based on a value obtained by inputting the feature vector vtj into the regression model f1.

### (Training of Regression Model)

As an example, the regression model f1 may be constructed by machine learning using training data including: the feature vector vsi representing each record sdi contained in the standard data SD; and the attribute value tsi[k] of the attribute k contained in the standard data SD. Here, as an example, the number of dimensions of the feature vector vsi may be the number of attributes contained in the standard data SD. As an example, the feature vectors vs1 to vs3 of the records sd1 to sd3 of the standard data SD illustrated in FIG. 4 may be expressed as {0.7, −0.4, 0.1, 0.8, −1.0}, {0.1, 0.4, −0.1, −1.2, 0.7}, and {0.9, 0.6, −0.3, 0.4, −0.8}, respectively.

It should be noted that the number of dimensions of the feature vector vsi is not limited to the number of attributes contained in the target data TD. For example, the prediction section 14 may use an embedded vector of the standard data SD as the feature vector vsi. In this case, the prediction section 14 can use any existing algorithm such as word2vec to obtain the embedded vector.

### (Second Specific Example of Predictive Model: Classification Model (Supervised Learning))

As an example, the predictive model f used by the prediction section 14 may be a classification model f2 generated by supervised learning. In this case, the attribute value of the attribute k of the standard data SD is data for identifying a category. In this case, input of the classification model f2 is the feature vector vtj of the target record tdj, and output of the classification model f2 is the pair of the correction candidate yck of the error attribute k and the corresponding first certainty factor sck. In other words, the prediction section 14 identifies the correction Pk based on a value obtained by inputting the feature vector vtj of the target data TD into the classification model f2.

### (Training of Classification Model)

As an example, the classification model f2 may be constructed by machine learning using training data including: the feature vector vsi; and the attribute value tsi[k] of the attribute k contained in the standard data SD. More specifically, as an example, the information processing apparatus 1A or the like may train the classification model f2 to minimize the following loss function E(θ).

$$E ( θ ) = - {\sum }_{i} {\sum }_{c} {y}_{c}^{i} log {f ( vsi ; θ )}_{c} \qquad ( 2 )$$

In Equation (2), y_{c}ⁱ takes the value “1” when the attribute value tsi[k] belongs to category c, and takes the value “0” otherwise. The f(vsi;θ)_{c} represents the first certainty factor for the category c.

In step S14, as an example, when the processed record tᵢₙᵢₜ has the contents exemplified in FIG. 7, output of the predictive model f may include the certainty factor of each of “baby equipment”, “sweets”, and “cosmetics”, which are the attribute values of the correction candidates in “category”, which is the error attribute k. The prediction section 14 outputs a correction Pk in accordance with a value outputted from the predictive model.

### (Method Using Similarity Vector)

As another example, the prediction section 14 may calculates a similarity vector between a target record tdj contained in the target data TD and each standard record sdi contained in standard data SD, and output, as the correction candidate yck, an attribute value contained in a standard record sdi having a greater matching probability obtained based on the calculated similarity vectors. In this case, as an example, the prediction section 14 may calculate n×m similarity vectors, and retrieve a similar record set that is a set of standard records sdi similar to the target record tdj, using the calculated similarity vectors. Further, the prediction section 14 aggregates attribute values of the error attribute k in the similar record set, to output the correction candidate yck of the error attribute k and the first certainty factor sck of the correction candidate yck.

### (Step S15)

In step S15, the revision section 15 revises the correction Pk with reference to the reference attribute k′. In the present example embodiment, the revision section 15 identifies the revised correction from among the plurality of correction candidates yck with reference to the reference attribute k′.

More specifically, as an example, the revision section 15 may calculate an evaluation function f(yck) of correction candidate yck, and identifies a correction candidate yck having the highest value of the evaluation function f(yck) from among the plurality of correction candidates yck as the revised correction.

As an example, the evaluation function f(yck) may be expressed by using (i) first certainty factor sck, (ii) second certainty factor pu, and (iii) similarity sim(yck,u). In other words, the revision section 15 obtains the first certainty factor sck, one or more attribute value candidates u, and the second certainty factor pu, calculates the similarity sim(yck,u), identifies the revised correction with reference to the plurality of correction candidates yck, the first certainty factor sck, the one or more attribute value candidates u, the second certainty factor pu, and the calculated similarity sim(yck,u).

Here, the second certainty factor pu is a certainty factor related to each of the one or more attribute value candidates u for the reference attribute k′. The one or more attribute value candidates u for the reference attribute k′ are candidates for the attribute value of the reference attribute k′. For example, when the reference attribute k′ is “type” contained in the target data TD, the one or more attribute value candidates u may be “food products”, “household goods”, or the like that can be an attribute value of “type”.

As the method of calculating the second certainty factor pu, for example, the revision section 15 may calculate the second certainty factor pu, using a predictive model f3 that outputs the second certainty factor pu for the attribute value candidate uϵU. As an example, the predictive model f3 may be constructed by machine learning. As an example, the predictive model f3 may be a predictive model that receives a feature vector vtj as input and outputs a second certainty factor pu of an attribute value u. The training of the predictive model f3 may be carried out by the control section 10A of the information processing apparatus 1A, or may be carried out by another apparatus. The machine learning method of the predictive model is not limited, and, for example, a decision tree-based, linear regression, or neural network technique may be used, or alternatively, two or more of these methods may be used. Examples of the decision tree-based method may include LightGBM, random forest, and XGBoost. Examples of the linear regression may include Bayesian linear regression, support vector regression, Ridge regression, Lasso regression, and ElasticNet. Examples of the neural network may include deep learning.

As an example, the predictive model f3 may be constructed by machine learning using training data including: the feature vector of each record contained in a database; and the attribute value of the attribute k contained in the database.

However, the unit for carrying out the calculation process of the second certainty factor pu is not limited to the revision section 15, and may be carried out by a unit other than the revision section 15, such as the prediction section 14. Further, the calculation process of the second certainty factor pu may be carried out by another apparatus other than the information processing apparatus 1A. For example, the data obtaining section 11 or the like may obtain the second certainty factor pu calculated by another apparatus via the input/output section 30A or the communication section 40A.

The similarity sim(yck,u) is a similarity between each of the plurality of correction candidates yck and each of the one or more attribute value candidates u. As an example, the revision section 15 may collect the words included in the plurality of correction candidates yck to generate a token set, and collect the words included in the one or more attribute value candidates u to generate a token set, and then, calculate the similarities between these token sets as the similarity sim(yck,u). In this case, the similarities between the sets may be, for example, the Jaccard coefficient, the Dice coefficient, or the Simpson coefficient.

As another example, the revision section 15 may handle each attribute value as a single character string and calculates the similarities between attribute values, to calculate the similarity sim(yck,u) based on the calculated similarities between the attribute values. In this case, the similarities between the attribute values may be, for example, the Hamming distance or the Levenshtein distance.

As another example, after obtaining embedded vectors of attribute values, the revision section 15 may calculate the distance between vectors, using a distance function. In this case, for example, word2vec's algorithm can be used when obtaining the embedded vectors. For example, the distance function may be a function for calculating the Euclidean distance or the Manhattan distance. However, the calculation method of the similarity (yck,u) is not limited to the foregoing examples, and the revision section 15 may calculate the similarity (yck,u) by another method.

As an example, the evaluation function f(yck) used by the revision section 15 in identifying the revised correction may be expressed by Equation (3), using the first certainty factor sck, the second certainty factor pu, and the similarity sim(yck,u).

$$f ( yck ) = sck + α [ {\sum }_{u ∈ U} pu \cdot sim ( yck , u ) ] \qquad ( 3 )$$

In Equation (3), the coefficient α(0≤α) is the degree of consideration of the similarity sim(yck,u). That is, the greater α is, the more important the similarity to the similarity sim(yck,u) is, and the smaller α is, the more important the first certainty factor sck is.

In Equation (3), the similarity between the attribute value candidate u and the correction candidate yck is weighted by the second certainty factor pu. However, if the attribute value u of the reference attribute k′ is known, the evaluation function f(yck) may be as follows, without considering the weighting of the second certainty factor pu.

$$f ( yck ) = sck + α \cdot sim ( yck , u )$$

It should be noted that the evaluation function f(yck) used by the revision section 15 is not limited to the foregoing examples, and the revision section 15 may identify the revised correction, using another evaluation function. The revision section 15 may be any section that revises the correction Pk with reference to the reference attribute k′; for example, the revision section 15 may identify the revised correction based on the result of the multiplication of the first certainty factor sck of the correction candidate yck and the similarity sim(yck,u).

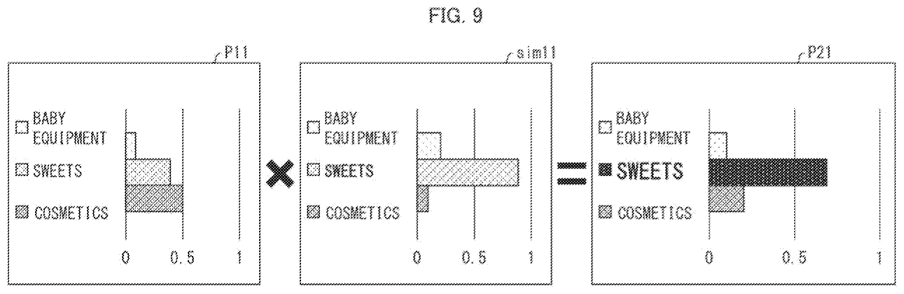

FIG. 9 is a diagram illustrating a specific example of the revision of the correction P carried out by the revision section 15. In FIG. 9, a correction P11 is a correction predicted by the prediction section 14, and includes: “baby equipment”, “sweets”, and “cosmetics”, which are a plurality of correction candidates yck for “category”, which is the error attribute k; and the first certainty factor sck of each correction candidate yck. In the example of FIG. 9, the first certainty factor sck of “cosmetics” is the highest among “baby equipment”, “sweets”, and “cosmetics”.

A similarity sim11 indicates the similarity sim(yck,u) calculated by the revision section 15 for each of “baby equipment”, “sweets”, and “cosmetics”, which are the plurality of correction candidates yck. In the example of FIG. 9, the similarity (yck,u) of “cosmetics” is the highest among “baby equipment”, “sweets”, and “cosmetics”.

A revised correction P21 shows the result of revision obtained by revising the correction P11 by the revision section 15 with reference to the reference attribute k′. The correction P21 indicates “baby equipment”, “sweets”, and “cosmetics”, which are the plurality of correction candidates yck for “category”, which is the error attribute k, and the value of the evaluation function f(yck) of each correction candidate yck. In the example of FIG. 9, the value of the evaluation function f(yck) of “sweets” is the highest among “baby equipment”, “sweets”, and “cosmetics”.

### (Step S150)

Step S150 is the end of the loop of the process related to the record contained in the target data TD.

### (Step S16)

In step S16, the converted data generation section 16 generates a converted record td2j corresponding to the record tdj of the target data TD, using the correction revised by the revision section 15. Further, the converted data generation section 16 integrates the generated converted record td2j into the standard data SD and generates integrated data ID. Here, among the records tdj contained in the target data TD, a record tdj which contains no error attribute has not been converted; in this case, the converted data generation section 16 substitutes the unconverted record tdj for the converted record td2j as it is.

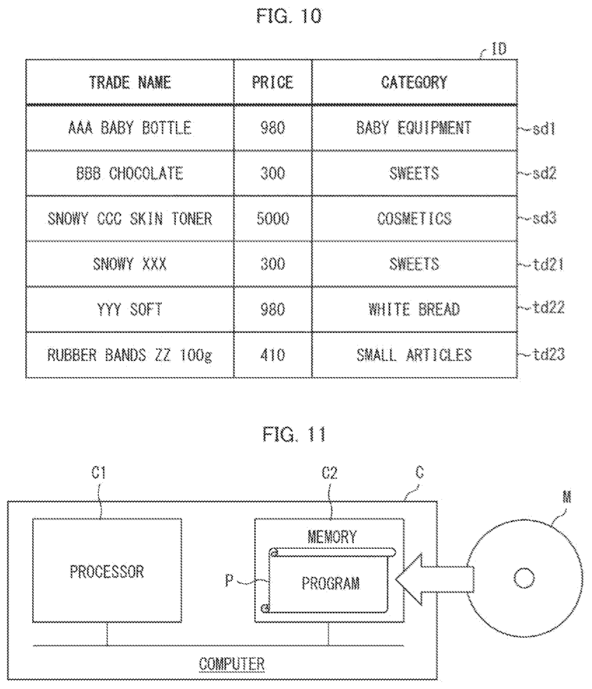

FIG. 10 is a diagram illustrating a specific example of the integrated data ID. The integrated data ID is data obtained by integrating the converted record td2j into the standard data SD. More specifically, the integrated data ID illustrated in FIG. 10 contains the records {sdi} of the basic data SD and the converted records {td2j} obtained by converting the records {tdj} of the target data TD.

In FIG. 10, the record td21 contains the attribute value “sweets” in the field “category”. Here, if the prediction result obtained by the prediction section 14 is used as it is, since “cosmetics” is the attribute value having the highest first certainty factor calculated by the prediction section 14 (see the correction P11 in FIG. 9), “cosmetics” is adopted as the attribute of the field “category”. In this case, the attribute value of “category” of the record td21 is not appropriate.

In contrast, the information processing apparatus 1A in accordance with the present example embodiment predicts a correction related to an error attribute k contained in a processed record tᵢₙᵢₜ, and revises the predicted correction Pk with reference to a reference attribute k′ similar to the error attribute k. For example, even in a case where the accuracy of the correction predicted by the information processing apparatus 1A is not sufficient, it is possible to correct an error with higher accuracy without requiring large amounts of training data by revising the predicted correction with reference to the reference attribute k′ similar to the error attribute k.

### (Application Example of Information Processing Apparatus 1A)

The foregoing second example embodiment has mainly discussed a case in which the information processing apparatus 1A integrates a plurality of databases, but the information processing apparatus 1A is not limited to an apparatus that integrates data. For example, the information processing apparatus 1A may be applied as a conversion apparatus that converts target data into a format of standard data, or as a classification apparatus that reclassifies data.

In a case where the information processing apparatus 1A is used as the conversion apparatus, the information processing apparatus 1A obtains target data that is a target of the conversion process, and converts the obtained target data into converted data, using a correction revised by the revision section 15. In this case, the target data that is a target of the conversion process may be, for example, a database that contains a plurality of records. Further, the converted data may be, for example, a database containing one or more attributes different from those of the target data.

In this case, similar to the second example embodiment described above, the information processing apparatus 1A identifies an error attribute that is an attribute including an error, from among a plurality of attributes contained in the processed data obtained by applying a predetermined process to the target data, and identifies a reference attribute that is an attribute similar to the error attribute and contained in the target data. The information processing apparatus 1A predicts a correction related to the error attribute and revises the correction with reference to the reference attribute. Further, the information processing apparatus 1A generates converted data corresponding to the target data, using the correction revised by the revision section 15.

Further, in a case where the information processing apparatus 1A is used as the reclassification apparatus, the information processing apparatus 1A obtains target data, which is a target to be classified, and reclassifies the obtained target data, using a correction revised by the revision section 15. In this case, the target data that is a target of the reclassification process, may be, for example, a database that contains a plurality of records. Further, converted data generated by the reclassification process may be, for example, a database containing one or more attributes different from those of the target data. The record contained in the converted data is classified by attribute value contained in the converted data.

In this case, similar to the second example embodiment described above, the information processing apparatus 1A identifies an error attribute that is an attribute including an error, from among a plurality of attributes contained in the processed data obtained by applying a predetermined process to the target data, and identifies a reference attribute that is an attribute similar to the error attribute and contained in the target data. The information processing apparatus 1A predicts a correction related to the error attribute and revises the correction with reference to the reference attribute. Further, the information processing apparatus 1A generates converted data corresponding to the target data, using the correction revised by the revision section 15.

Examples of applications for reclassification of data may include, for example, update of a commodity classification taxonomy (classification system) in electronic commerce, use in document classification, and use in other classifications such as those of financial goods. Examples of the document classification may include reclassification of patent literature, and reclassification of academic papers (e.g., arXiv, etc.). Other examples may include diseases classification or the like performed by the World Health Organization (WHO).

### [Software Implementation Example]

Some or all of the functions of each of the information processing apparatuses 1 and 1A may be implemented by hardware such as an integrated circuit (IC chip), or may be alternatively implemented by software.

In the latter case, the information processing apparatuses 1 and 1A are implemented by, for example, a computer that executes instructions of a program that is software implementing the foregoing functions. FIG. 11 illustrates an example of such a computer (hereinafter, referred to as “computer C”). The computer C includes at least one processor C1 and at least one memory C2. The memory C2 stores a program P for causing the computer C to operate as the information processing apparatuses 1 and 1A. The processor C1 of the computer C retrieves the program P from the memory C2 and executes the program P, so that the functions of the information processing apparatuses 1 and 1A are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following supplementary notes.

### (Supplementary Note 1)

An information processing apparatus including:
data obtaining means for obtaining target data;
error attribute identification means for identifying an error attribute that is an attribute including an error, from among a plurality of attributes contained in processed data obtained by applying a predetermined process to the target data;
reference attribute identification means for identifying a reference attribute that is an attribute similar to the error attribute and contained in the target data;
prediction means for predicting a correction related to the error attribute; and
revision means for revising the correction with reference to the reference attribute.

With this configuration, it is possible to correct an error related to an attribute of data with high accuracy without requiring large amounts of training data.

### (Supplementary Note 2)

The information processing apparatus according to Supplementary note 1, wherein
the prediction means predicts a plurality of correction candidates related to the error attribute, and
the revision means identifies a revised correction from among the plurality of correction candidates with reference to the reference attribute.

With this configuration, the information processing apparatus identifies the correction from among the plurality of correction candidates with reference to the reference attribute similar to the error attribute. Thus, it is possible to correct the error with high accuracy without requiring large amounts of training data, as compared with a case where no correction is identified with reference to the reference attribute.

### (Supplementary Note 3)

The information processing apparatus according to Supplementary note 2, wherein
the revision means obtains:
   a first certainty factor that is a certainty factor related to each of the plurality of correction candidates;
   one or more attribute value candidates for the reference attribute; and
   a second certainty factor that is a certainty factor related to each of the one or more attribute value candidates,
the revision means calculates a similarity between each of the plurality of correction candidates and each of the one or more attribute value candidates, and
the revision means identifies the revised correction with reference to the plurality of correction candidates, the first certainty factor, the one or more attribute value candidates, the second certainty factor, and the similarity.

With this configuration, the revised correction is identified with reference to the plurality of correction candidates, the first certainty factor, the one or more attribute value candidates, the second certainty factor, and the similarity. Thus, it is possible to correct the error with high accuracy without requiring large amounts of training data.

### (Supplementary Note 4)

The information processing apparatus according to Supplementary note 2 or 3, wherein the prediction means calculates a feature vector of a target record contained in the target data, inputs the calculated feature vector into a predictive model, and outputs a correction candidate in accordance with a value outputted from the predictive model.

With this configuration, the information processing apparatus predicts the correction candidate in accordance with the value outputted from the predictive model. When the training data for the training of the predictive model is not sufficient, the reliability of the correction candidate in accordance with the output of the predictive model may be low. In contrast, with the above configuration, revision of the predicted correction candidate in accordance with the reference attribute can correct the error with high accuracy even in a case where the reliability of the correction candidate is low.

### (Supplementary Note 5)

The information processing apparatus according to any one of Supplementary notes 2 to 4, wherein the prediction means calculates a similarity vector between a target record contained in the target data and each standard record contained in standard data, and outputs, as a correction candidate, an attribute value contained in a standard record having a greater matching probability obtained based on the calculated similarity vectors.

With this configuration, revision of the correction candidate in accordance with the reference attribute can correct the error with high accuracy even in a case where the reliability of the correction candidate is low.

### (Supplementary Note 6)

The information processing apparatus according to any one of Supplementary notes 1 to 5, wherein the reference attribute identification means identifies a reference attribute that is an attribute similar to the error attribute semantically or linguistically and contained in the target data.

With this configuration, it is possible to correct the error with higher accuracy by revising the correction with use of the reference attribute that is similar to the error attribute semantically or linguistically.

### (Supplementary Note 7)

The information processing apparatus according to any one of Supplementary notes 1 to 6, further including initialization means for applying an initialization process to the target data as the predetermined process,
wherein, as the initialization process, the initialization means: refers to correspondence information indicating a correspondence between at least one of the plurality of attributes contained in the target data and at least one of a plurality of attributes contained in standard data; and, from the target data, generates, as the processed data, data containing attributes identical to the plurality of attributes contained in the standard data.

With this configuration, the correction of the processed data obtained by applying the initialization process to the target data is revised with reference to the reference attribute similar to the error attribute. Thus, it is possible to correct the error included in the processed data with high accuracy without requiring large amounts of training data.

### (Supplementary Note 8)

The information processing apparatus according to Supplementary note 7, wherein the error attribute identification means determines, for each of the plurality of attributes contained in the processed data, whether or not an attribute value of the attribute satisfies a predetermined condition, and identifies the error attribute based on a result of the determination.

With this configuration, the correction is revised with reference to the reference attribute that is similar to the error attribute identified based on the determination result of whether or not the attribute value satisfies the predetermined condition. Thus, it is possible to correct the error with high accuracy without requiring large amounts of training data.

### (Supplementary Note 9)

The information processing apparatus according to any one of Supplementary notes 1 to 8, further including converted data generation means for generating converted data corresponding to the target data, using the correction revised by the revision means.

With this configuration, it is possible to correct the error due to the conversion with high accuracy without requiring large amounts of training data when the target data is converted into the converted data.

### (Supplementary Note 10)

An information processing method including:
obtaining target data;
identifying an error attribute that is an attribute including an error, from among a plurality of attributes contained in processed data obtained by applying a predetermined process to the target data;
identifying a reference attribute that is an attribute similar to the error attribute and contained in the target data;
predicting a correction related to the error attribute; and
revising the correction with reference to the reference attribute.

With this information processing method, it is possible to achieve an example advantage similar to that achieved by the abovementioned information processing apparatus.

### (Supplementary Note 11)

An information processing program for causing a computer to carry out:
a process of obtaining target data;
a process of identifying an error attribute that is an attribute including an error, from among a plurality of attributes contained in processed data obtained by applying a predetermined process to the target data;
a process of identifying a reference attribute that is an attribute similar to the error attribute and contained in the target data;
a process of predicting a correction related to the error attribute; and
a process of revising the correction with reference to the reference attribute.

With this configuration, it is possible to achieve an example advantage similar to that achieved by the abovementioned information processing apparatus.

### [Additional Remark 3]

Furthermore, some of or all of the above example embodiments can also be expressed as below.

An information processing apparatus including at least one processor, the processor including: a data obtaining process of obtaining target data; an error attribute identification process of identifying an error attribute that is an attribute including an error, from among a plurality of attributes contained in processed data obtained by applying a predetermined process to the target data; a reference attribute identification process of identifying a reference attribute that is an attribute similar to the error attribute and contained in the target data; a prediction process of predicting a correction related to the error attribute; and a revision process of revising the correction with reference to the reference attribute.

Note that the information processing apparatus may further include a memory, which may store therein a program for causing the at least one processor to carry out the data obtaining process, the error attribute identification process, the reference attribute identification process, the prediction process, and the revision process. Alternatively, the program may be stored in a computer-readable, non-transitory, tangible storage medium.

### REFERENCE SIGNS LIST

1, 1A Information processing apparatus
10A Control section
11 Data obtaining section
12 Error attribute identification section
13 Reference attribute identification section
14 Prediction section
15 Revision section
16 Converted data generation section
20A Storage section
30A Input/output section
40A Communication section
111 Initialization section
C1 Processor
C2 Memory

What is claimed is:

1. An information processing apparatus comprising at least one processor, the at least one processor carrying out:
a data obtaining process of obtaining target data;
an error attribute identification process of identifying an error attribute that is an attribute including an error, from among a plurality of attributes contained in processed data obtained by applying a predetermined process to the target data;
a reference attribute identification process of identifying a reference attribute that is an attribute similar to the error attribute and contained in the target data;
a prediction process of predicting a correction related to the error attribute; and
a revision process of revising the correction with reference to the reference attribute.

2. The information processing apparatus according to claim 1, wherein
in the prediction process, the at least one processor predicts a plurality of correction candidates related to the error attribute, and
in the revision process, the at least one processor identifies a revised correction from among the plurality of correction candidates with reference to the reference attribute.

3. The information processing apparatus according to claim 2, wherein, in the revision process,
the at least one processor obtains:
a first certainty factor that is a certainty factor related to each of the plurality of correction candidates;
one or more attribute value candidates for the reference attribute; and
a second certainty factor that is a certainty factor related to each of the one or more attribute value candidates,
the at least one processor calculates a similarity between each of the plurality of correction candidates and each of the one or more attribute value candidates, and
the at least one processor identifies the revised correction with reference to the plurality of correction candidates, the first certainty factor, the one or more attribute value candidates, the second certainty factor, and the similarity.

4. The information processing apparatus according to claim 2, wherein in the prediction process, the at least one processor calculates a feature vector of a target record contained in the target data, inputs the calculated feature vector into a predictive model, and outputs a correction candidate in accordance with a value outputted from the predictive model.

5. The information processing apparatus according to claim 2, wherein in the prediction process, the at least one processor calculates a similarity vector between a target record contained in the target data and each standard record contained in standard data, and outputs, as a correction candidate, an attribute value contained in a standard record having a greater matching probability obtained based on the calculated similarity vectors.

6. The information processing apparatus according to claim 1, wherein in the reference attribute identification process, the at least one processor identifies a reference attribute that is an attribute similar to the error attribute semantically or linguistically and contained in the target data.

7. The information processing apparatus according to claim 1, wherein
the at least one processor further carries out an initialization process to the target data as the predetermined process, and
in the initialization process, the at least one processor: refers to correspondence information indicating a correspondence between at least one of the plurality of attributes contained in the target data and at least one of a plurality of attributes contained in standard data; and, from the target data, generates, as the processed data, data containing attributes identical to the plurality of attributes contained in the standard data.

8. The information processing apparatus according to claim 7, wherein in the error attribute identification process, the at least one processor determines, for each of the plurality of attributes contained in the processed data, whether or not an attribute value of the attribute satisfies a predetermined condition, and identifies the error attribute based on a result of the determination.

9. The information processing apparatus according to claim 1, wherein the at least one processor further carries out a converted data generation process of generating converted data corresponding to the target data, using the correction revised in the revision process.

10. An information processing method comprising:
obtaining target data;
identifying an error attribute that is an attribute including an error, from among a plurality of attributes contained in processed data obtained by applying a predetermined process to the target data;
identifying a reference attribute that is an attribute similar to the error attribute and contained in the target data;
predicting a correction related to the error attribute; and
revising the correction with reference to the reference attribute.

11. A computer-readable non-transitory storage medium storing therein a program for causing a computer to function as an information processing apparatus and for causing a computer to carry out:
a process of obtaining target data;
a process of identifying an error attribute that is an attribute including an error, from among a plurality of attributes contained in processed data obtained by applying a predetermined process to the target data;
a process of identifying a reference attribute that is an attribute similar to the error attribute and contained in the target data;
a process of predicting a correction related to the error attribute; and
a process of revising the correction with reference to the reference attribute.
